(19) United States
(12) Patent Application Publication
(10) Pub. No.: US 2003/0064883 A1
(43) Pub. Date: Apr. 3, 2003

(54) Catalysts for olefin polymerization

(76) Inventors: Michael Arndt-Rosenau, Dormagen (DE); Martin Hoch, Heinsberg (DE); Jorg Sundermeyer, Marburg (DE); Jennifer Kipke, Mannheim (DE)

Correspondence Address: BAYER CORPORATION, PATENT DEPARTMENT, 100 BAYER ROAD, PITTSBURGH, PA, 15205, US

(21) Appl. No.: 10/219,894

(22) Filed: Aug. 15, 2002

(30) Foreign Application Priority Data
Aug. 16, 2001 (DE) 10140203.1

(51) Int. Cl. B01J 31/00

(52) U.S. Cl. 502/155; 502/150; 502/152; 502/167; 526/172; 526/348

(57) ABSTRACT

The present invention relates to diimine transition metal compounds having aryl groups with one or more electron-attracting substituents, compositions containing diimine transition metal compounds having aryl groups with one or more electron-attracting substituents, which are useful as catalysts for the polymerization of olefins, such as ethene/propene or ethene/α-olefin copolymerization.

### FIELD OF THE INVENTION

The present invention relates to diimine transition metal compounds having aryl groups with one or more electron-attracting substituents, and compositions containing diimine transition metal compounds, which are catalysts for the polymerization of olefins, in particular ethene/propene or ethene/α-olefin copolymerization.

### BACKGROUND OF THE INVENTION

WO-96/23010-A2 describes the use of transition metal complexes based on diimine ligands for the polymerization of olefins and the copolymerization of olefins with polar monomers. The patent teaches that [diimine]Ni and Pd complexes based on aromatic amines such as aniline or p-methyl aniline produce only oligomers when reacted with ethene (p. 94, 136). In order to synthesize polymers, o- or o,o′-substituted anilines must be used.

WO-98/40374-A2 describes corresponding complexes with electron-attracting substituents on the bridge of the chelating ligand.

In Organometallics 16, (1997), 2005-2007, M. Brookhart and C. M. Killian et al. write: “We reasoned by eliminating the steric bulk of the ortho-substituents, rates of associate chain transfer should be substantially increased, resulting in oligomerization rather than polymerization reactions.” and oligomers alone are indeed obtained using diimines of aniline or p-methyl aniline.

Detailed investigations into this phenomenon are described by Brookhart et al. in Organometallics 18 (1999), 65-74 and by Brookhart and Killian et al. in Macromolecules 33, (2000), 2320-2334. They conclude that: “(1) As the bulk of the ortho aryl substituents on the α-diimine increases, the molecular weight of the polyethylenes increases. With mono ortho substituted aryl diimine catalysts Mn values as low as ca. 1000 are seen . . . (2) Increased steric bulk of the ortho substituents also increases . . . the turnover frequencies.”

L. K. Johnson and C. M. Killian wrote (in J. Sheirs, W. Kaminsky: Metallocene-based polyolefins Volume One, Chapter 11; J. Wiley & Sons: New York (1999)): “ . . . key features of the α-diimine polymerization catalysts are . . . the incorporation of bulky α-diimine Ligands”.

These statements suggest that diimines without bulky ortho substituents as catalysts in olefin polymerization with low activity produce oligomers.

However, since the incorporation of monomers, that are more sterically demanding than ethene, is impeded by large substituents in the ortho position, there is an interest in developing polymerization catalysts that do not carry ortho substituents on the diimine.

### SUMMARY OF THE INVENTION

Surprisingly it was found that diimines without ortho substituents that display electron-attracting substituents on the aniline fragment catalyze the polymerization of ethene with high activities.

### DETAILED DESCRIPTION OF THE INVENTION

The invention therefore provides diimine transition metal compounds having aryl groups with one or more electron-attracting substituents, preferably a compound having the general formula (I)

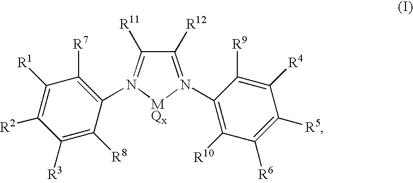

wherein

M is selected from manganese, iron, ruthenium, cobalt, rhodium, nickel, palladium and copper,

Q is a mono-anionic or non-anionic ligand,

R¹, R², R³, R⁴, R⁵, R⁶ are mutually independently selected from the group consisting of electron-attracting substituent, hydrogen, optionally substituted C₁-C₁₀ alkyl groups, optionally substituted C₆-C₁₄ aryl radicals and whereby one or more of R¹ to R⁶ can optionally be parts of a ring system, wherein at least one of these groups, but preferably several, particularly preferably more than 3 of these groups, is an electron-attracting substituent (a substituent which lowers the electron density of the aromatic),

R⁷, R⁸, R⁹, R¹⁰ are mutually independently selected from hydrogen, halogen, C₁-C₁₀ alkyl, wherein at least two of the groups are hydrogen or halogen, however,

R¹¹ and R¹² are mutually independently selected from hydrogen, halogen, substituted C₁-C₁₀ alkyl group, substituted C₆-C₁₄ aryl radical and whereby one or more of R¹¹ to R¹² can optionally be parts of a ring system or are bonded by hetero atoms to the imine carbons,

x represents a whole number in the range from 1 to 3.

3 or 4 of the groups R⁷, R⁸, R⁹, R¹⁰ are preferably hydrogen, MORE preferably all four.

All groups known to the person skilled in the art that lower the electron density of the corresponding aryl group, such as halogen, halogenated alkyl groups, nitro, cyano, carbonyl and carboxyl groups, are suitable as electron-attracting substituents.

Halogen and perhalogenated alkyl groups are preferably used as the electron-attracting substituents. Chlorine, bromine, iodine and perfluorinated alkyl substituents are more preferred.

All ligands known to the person skilled in the art that can be abstracted with the metal complex cation-forming compound to form non-coordinating or weakly coordinating anions can be used as the mono-anionic or non-anionic ligand Q. The Qs can be the same or different, one or more of the two Q groupings can also be bridged. Q is preferably selected from halide, especially chloride and bromide, hydride or methyl, ethyl, butyl. Reference is made to W. Beck et al., Chem. Rev. 88, 1405-1421 (1988) and S. Strauss 93, 927-42 (1993) with regard to non-coordinating or weakly coordinating anions.

Q is selected from halide, hydride, C₁ to C₁₀ alkyl or alkenyl, C₆-C₁₀ cycloalkyl, C₆-C₁₄ aryl, alkyl aryl with a C₁ to C₁₀ grouping in the alkyl radical and a C₆ to C₁₄ grouping in the aryl radical, —OR¹³, OR¹³R¹⁴, —NR¹⁵R¹⁶, NR¹⁵R¹⁶R¹⁷, —PR¹⁵R¹⁶, —PR¹⁵R¹⁶R¹⁷, and whereby R¹³ to R¹⁷ can be selected from H, C₁ to C₁₀ alkyl, C₆ to C₁₀ cycloalkyl, C₆ to C₁₄ aryl, alkyl aryl or aryl alkyl and can be the same or different.

The person skilled in the art understands halogen to refer to fluorine, chlorine, bromine or iodine, wherein chlorine and bromine are preferred.

The term C₁-C₁₀ alkyl refers to all linear or branched alkyl radicals with 1 to 10 C atoms known to the person skilled in the art, such as methyl, ethyl, n-propyl, i-propyl, n-butyl, i-butyl, t-butyl, n-pentyl, i-pentyl, neo-pentyl and hexyl, heptyl, octyl, nonyl and decyl, which can in turn themselves be substituted. Suitable substituents are halogen, nitro, hydroxyl, or C₁-C₁₀ alkyl, as well as C₆-C₁₄ cycloalkyl or aryl, such as benzoyl, trimethyl phenyl, ethyl phenyl, chloromethyl, chloroethyl and nitromethyl.

The term C₆-C₁₄ cycloalkyl refers to all mononuclear or polynuclear cycloalkyl radicals with 6 to 14 C atoms known to the person skilled in the art, such as cyclohexyl, cycloheptyl, cyclooctyl and cyclononyl or partially or fully hydrogenated fluorenyl, which can in turn themselves be substituted. Suitable substituents are halogen, nitro, C₁-C₁₀ alkoxy or C₁-C₁₀ alkyl, as well as C₆-C₁₂ cycloalkyl or aryl, such as methylcyclohexyl, chlorocyclohexyl and nitrocyclohexyl.

The term C₆-C₁₄ aryl refers to all mononuclear or polynuclear aryl radicals with 6 to 14 C atoms known to the person skilled in the art, such as phenyl, naphthyl, fluorenyl, which can in turn themselves be substituted. Suitable substituents include halogen, nitro, C₁-C₁₀ alkoxy or C₁-C₁₀ alkyl, as well as C₆-C₁₄ cycloalkyl or aryl, such as bromophenyl, chlorophenyl, toluyl and nitrophenyl.

The term aryl refers to all mononuclear or polynuclear aryl radicals with 6 to 14 C atoms known to the person skilled in the art, such as phenyl, naphthyl, anthracenyl, phenanthrenyl and fluorenyl, which can in turn themselves be substituted. Suitable substituents are halogen, nitro or alkyl or alkoxyl, as well as cycloalkyl or aryl, such as bromophenyl, chlorophenyl, toluyl and nitrophenyl.

The term alkyl refers to all linear or branched alkyl radicals with 1 to 50 C atoms known to the person skilled in the art, such as methyl, ethyl, n-propyl, i-propyl, n-butyl, i-butyl, t-butyl, n-pentyl, i-pentyl, neo-pentyl, hexyl and the other homologues, which can in turn themselves be substituted. Suitable substituents include halogen, nitro, or alkyl or alkoxy, as well as cycloalkyl or aryl, such as phenyl, trimethyl phenyl, ethyl phenyl, chloromethyl, chloroethyl and nitromethyl. Methyl, ethyl, n-propyl, i-propyl, n-butyl, i-butyl, t-butyl and benzoyl are preferred.

More preferably in formula (I)

M represents Ni or Pd,

Q represents chloride, bromide or methyl,

R¹, R³, R⁴, R⁶ mutually independently represent halogen, perhaloalkyl

R² and R⁵ represents hydrogen, alkyl or aryl

R⁷, R⁸, R⁹, R¹⁰ represent hydrogen

R¹¹, R¹² represents hydrogen, alkyl or rings

x is 2 or 3.

The present invention also relates to compositions containing a diimine transition metal compound having an aryl groups with one or more electron-attracting substituents and at least one metal complex cation-forming compound.

The diimine transition metal compound or the diimine transition metal compounds are used in the range from 10⁻¹⁰ to 10⁻¹ mol % relative to the (total) monomer concentration, preferably in the range from 10⁻⁸ to 10⁻⁴ mol %. More preferably, the concentration can easily be determined by means of a few preliminary trials.

Open-chain or cyclic aluminoxane compounds that preferably satisfy the general formula II or III, can, for example, be used as the metal complex cation-forming compound,

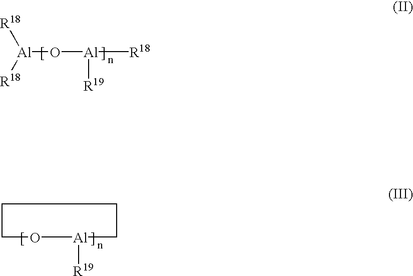

wherein

R¹⁸ and R¹⁹ represent a C₁-C₈ alkyl group, preferably a methyl or ethyl group, and n is a whole number from 3 to 30, preferably 10 to 25.

The production of these oligomeric aluminoxane compounds is conventionally performed by reacting a trialkyl aluminum solution with water and is described inter alia in EP-A1-0 284 708. The oligomeric aluminoxane compounds obtained in this way are generally in the form of mixtures of both linear and cyclic molecules of differing lengths, such that n must be regarded as a mean value. These aluminoxane compounds can also be in the form of a mixture with other metal alkyls, preferably with aluminum alkyls.

It has proven advantageous to use the compound having the general formula (I) and the oligomeric aluminoxane compound in quantities such that the molar ratio between the aluminum from the aluminoxane component and that from (I) is in the range from 1:1 to 20000:1, preferably in the range from 10:1 to 2000:1.

Open-chain coordination complex compounds selected from the group of strong, neutral Lewis acids, ionic compounds with Lewis acid cations or Brønsted acid cations and non-coordinating anions can also be used as the metal complex cation-forming compound.

Compounds having the general formula IV are preferred as strong neutral Lewis acids,

M²X¹X²X³ (IV)

in which

M² represents a group 3 element, in particular B, Al or Ga, preferably B,

X¹, X² and X³ represent H, C₁-C₁₀ alkyl, C₁-C₁₄ cycloalkyl, C₆-C₁₄ aryl, alkyl aryl, aryl alkyl, haloalkyl, haloaryl, haloalkyl aryl or haloaryl alkyl, each having C₁-C₁₀ alkyl, C₆ to C₁₄ cycloalkyl and C₆ to C₁₄ aryl radicals, or/and fluorine, chlorine, bromine or iodine, preferably haloaryls, more preferably perfluoro-substituted.

Compounds having the general formula (IV), in which X¹, X² and X³ are the same, preferably tris(pentafluorophenyl)borane, are preferably used for the present invention. These compounds and processes for their production are known per se and are described inter alia in WO-93/03067-A1. Also more preferred are aluminum trialkyls and dialkyl hydrides, such as trimethyl aluminum, triethyl aluminum, triisobutyl aluminum, trioctyl aluminum, diisobutyl aluminum hydride, as well as dialkyl aluminum halides and alkyl aluminum dichlorides and mixtures thereof.

Compounds having the general formula (V) are suitable as ionic compounds with Lewis or Brønsted acid cations and non-coordinating anions,

[L]^{d+}[(M²)^{m+}A₁A₂ . . . Aₖ]^{d-} (V)

wherein

L represents a Lewis acid cation according to the Lewis theory of acids and bases, preferably carbonium, oxonium or/and sulfonium cations as well as cationic transition metal complexes, preferably triphenyl methyl cation, silver cation or ferrocenyl cation, or L represents a Brønsted acid cation according to the Brønsted theory of acids and bases, preferably trialkyl ammonium, dialkyl aryl ammonium, or/and alkyl diaryl ammonium, more preferably N,N-dimethyl anilinium,

M² represents a group 3 element, in particular B, Al or Ga, preferably B,

A₁ to Aₖ stand for uninegative radicals, such as hydride, C₁ to C₂₈ alkyl, C₆ to C₁₄ cycloalkyl, C₆ to C₁₄ aryl, alkyl aryl, aryl alkyl, haloalkyl, haloaryl, haloalkyl aryl or haloaryl alkyl, each having C₁ to C₂₈ alkyl, C₁ to C₁₄ cycloalkyl and C₆ to C₁₄ aryl radicals, or halogen, alkoxide, aryl oxide or organometalloid, and A₁ to Aₖ are the same or different,

d is a whole number from 1 to 6 and d=k−m,

k represents whole numbers from 2 to 8, and

m is a whole number from 1 to 6.

Preferred anions [(M²)^{m+}A₁A₂ . . . Aₖ]^{d-} having the general formula V are those in which A₁ to Aₖ equal space-filling, perfluoro-substituted, aromatic hydrocarbon radicals and M² equals boron or aluminum, preferably tetrakis(pentafluorophenyl)borate.

It is advantageous to use the compound having the general formula (I) and the compound having the general formulae (IV) or (V) in quantities such that the molar ratio between M² from (IV) or (V) and M from (I) is in the range from 0.25:1 to 1:40, preferably in the range from 1:1 to 1:10.

Mixtures of different compounds having the general formula (I) and mixtures of different metal complex cation-forming compounds can also be used.

An alkylating agent can optionally be used, wherein the relative molar ratios between the diimine transition metal compound, a compound having the general formulae (IV) or (V) and the alkylating agent is preferably in the range from 1:0.25:2 to 1:40:10000, more preferably in the range from 1:1:10 to 1:5:1000.

Aluminum compounds that satisfy the general formula (VI) can for example be used as the alkylating agent,

Al(R²⁰)₃₋ⱼ(X⁴)ⱼ (VI)

wherein

R²⁰ represents a C₁ to C₈ alkyl group, preferably a methyl, ethyl and i-butyl group,

X⁴ represents fluorine, chlorine, bromine or iodine, preferably chlorine, and

j represents a whole number between 0 and 2.

The diimine compounds and compositions according to the present invention are suitable as catalysts, particularly as catalysts for the polymerization of olefins, such as ethene homopolymerization and ethene/α-olefin copolymerization. The present invention therefore also provides the use of the diimine compounds and/or compositions according to the present invention as catalysts, preferably for the homopolymerization and copolymerization of olefins, such as ethene, propene, 1-butene, 2-butene, isobutene, 1-pentene, 1-hexene, 4-methyl-1-pentene, 1-heptene, 3-methyl-1-hexene, 1-octene, cyclopentene, norbornene, preferably for ethene homopolymerization and ethene/α-olefin copolymerization.

The diimine compounds and/or compositions according to the present invention can be applied to a support in order to produce a catalyst.

Particulate, organic or inorganic solids whose pore volume is between 0.1 and 15 ml/g, preferably between 0.25 and 5 ml/g, whose specific surface area is greater than 1, preferably 10 to 1000 m²/g (BET), whose particle size is between 10 and 2500 μm, preferably between 50 and 1000 μm, and whose surface can be modified by suitable means, are preferably used as support materials.

The specific surface area is determined in the conventional way as described by Brunauer, Emmet and Teller, J. Anorg. Chem. Soc. 1938, 60, 309, the pore volume by the centrifuging method as described by McDaniel, J. Colloid Interface Sci. 1980, 78, 31 and the particle size as described by Cornillaut, Appl. Opt. 1972, 11, 265.

Suitable inorganic solids that can be cited by way of example, without however wishing to restrict the scope of the present invention, include: silica gels, precipitated silicas, clays, alumosilicates, talc, zeolites, carbon black, inorganic oxides, such as e.g. silicon dioxide, aluminum oxide, magnesium oxide, titanium dioxide, inorganic chlorides, such as e.g. magnesium chloride, sodium chloride, lithium chloride, calcium chloride, zinc chloride, or calcium carbonate. The inorganic are suitable for use as support materials are described in more detail in for example Ullmanns Enzyklopädie der technischen Chemie, volume 21, p. 439 et seq (silica gels), volume 23, p. 311 et seq (clays), volume 14, p. 633 et seq (carbon blacks) and volume 24, p. 575 et seq (zeolites).

Powdered, polymeric materials, preferably in the form of free-flowing powders, having the above properties are suitable as organic solids. Examples that can be cited without wishing to restrict the scope of the present invention include: polyolefins, such as e.g. polyethene, polypropene, polystyrene, polystyrene-co-divinyl benzene, polybutadiene, polyethers, such as e.g. polyethylenylene oxide, polyoxytetramethylene, or polysulfides, such as e.g. poly-p-phenylene sulfide. Preferably the materials are polypropylene, polystyrene or polystyrene-co-divinyl benzene. The cited organic solids that satisfy the above specification and are therefore suitable for use as support materials are described in more detail in for example Ullmanns Enzyklopädie der technischen Chemie, volume 19, p. 195 et seq (polypropylene) and volume 19, p. 265 et seq (polystyrene).

Production of the supported catalysts can take place within a broad temperature range, for example by mixing a solution of the diimine compounds and/or compositions according to the invention in an inert solvent/solvent blend with the optionally pretreated support material, followed by removal of the solvent/solvent blend.

The production temperature is thus generally between the melting point and boiling point of the inert solvent blend. Production is generally performed at temperatures of −50 to +200° C., preferably −20 to 100° C., more preferably 20 to 60° C.,

The invention also concerns a process for the homopolymerization or copolymerization of olefins, preferably ethene, propene, isobutene, 1-butene, 2-butene, 1-hexene, 1-octene, 4-methyl-1-pentene, unsaturated alicyclic compounds such as e.g. cyclopentene, norbornene, and a process for the copolymerization of these monomers with one or more dienes, preferably ethylidene norbornene, vinyl norbornene, dicyclopentadiene, 1,4-hexadiene. The invention furthermore concerns a process for the homopolymerization and copolymerization of conjugated dienes such as butadiene and isoprene and their copolymerization with olefins, alicyclic olefins, styrene and styrene derivatives, and polar vinyl monomers, such as e.g. acrylonitrile, methyl acrylate, butyl acrylate, methyl methacrylate.

The polymerization is preferably performed by dissolving the α-olefins with the catalyst according to the present invention or by bringing them into contact with the supported catalyst as a suspension in suitable solvents, in gaseous form, in finely divided liquid form or suspended in the liquid diluting agent.

Other gases or finely divided liquids that serve either dilution, atomization or thermal dissipation can be added to the gaseous, liquid or atomized monomers.

Liquids or liquefied gases known to the person skilled in the art that do not negatively influence the polymerization and the catalyst system are suitable as the diluting agent or solvent, particularly saturated hydrocarbons such as pentane, hexane, cyclohexane, benzine and petroleum ether.

The polymerization can be performed at pressures of 0.001 bar to 1000 bar, preferably 0.1 to 100 bar, more preferably 1 to 20 bar. The polymerization is generally performed at temperatures of −20 to 250° C., preferably 0 to 200° C., more preferably 20 to 160° C.

The present invention also provides the use of the polymers obtainable according to the present invention to produce moldings of all types, especially films, sheets, tubes, profiles, sheathings, extrudates and injection molded articles. Said polymers are characterized by a markedly narrower distribution of the number-average and weight-average molecular weights.

The examples below are intended to illustrate the present invention and the performance of homopolymerization and copolymerization processes catalyzed therewith.

### EXAMPLES

Unless otherwise specified, all chemicals used were obtained from Aldrich.

### Example 1

### Synthesis of [(3,5-(CF₃)₂Ph)₂GLY]

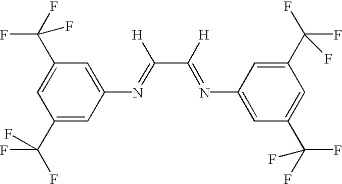

1.45 g (10 mmol, 40% solution in H₂O) glyoxal are introduced into 20 ml methanol, 5 drops of formic acid are added, and the system is cooled to 0° C. A solution of 4.58 g (3.12 ml, 20 mmol) 3,5-bis(trifluoromethyl)aniline in 20 ml methanol is slowly added dropwise with stirring. The reaction mixture becomes turbid after around 1 h, after stirring for 24 h at room temperature a white solid has been precipitated, which is filtered off from the parent liquor and recrystallized twice from methanol.

Yield 3.51 g (73%)

¹H-NMR (200 MHz, CDCl₃): 6.53 (s, 4H, Ar—Hₒᵣₜₕₒ), 7.24 (2, 2H, ArHₚₐᵣₐ), 8.07 (s, 2H, N═CH) ppm.

19F-NMR (188 MHz, CDCl₃): −63.24 (CF₃) ppm

IR (nujol): 1630s, 1615m, 1280s, 1163vs, 1142vs, 960m, 906m, 883vs, 845s, 731m, 699s, 683s, 591m, 571w, 546w, 522w, 492w, 438w cm⁻¹

EI-MS: m/z=480 (M⁺, 18%), 213 (C₈F₆H₃⁺, 100%)

### Example 2

### Synthesis of [(3,5-(CF₃)₂Ph)₂BUD]

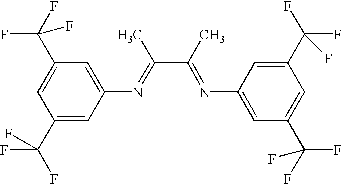

861 mg (10 mmol) diacetyl are introduced into 20 ml methanol, 5 drops of formic acid are added, and the system is cooled to 0° C. A solution of 4.58 g (3.12 ml, 20 mmol) 3,5-bis(trifluoromethyl)aniline in 20 ml methanol is slowly added dropwise with stirring. The reaction mixture is stirred for 24 h, a yellow solid is formed which is filtered off, washed with cold methanol and dried.

Yield 3.96 g (78%)

¹H-NMR (200 MHz, CDCl₃): 1.81 (s, 6H, CH₃), 6.43 (s, 4H, Ar—Hₒᵣₜₕₒ), 7.64 (2, 2H, ArHₚₐᵣₐ) ppm.

19F-NMR (188 MHz, CDCl₃): −63.03 (CF₃) ppm

IR (nujol): 1618s, 1221s, 1167vs, 1138vs, 1055s, 1013w, 999m, 920w, 895m, 864m, 802w, 763w, 731m, 683s, 553w, 530w, 488w, 451w cm⁻¹

EI-MS: m/z=508 (M⁺, 24%), 254 (C₁₀F₆H₆N⁺, 34%), 213 (C₈F₆H₃⁺, 100%)

### Example 3

### Synthesis of [(3,5-(CF₃)₂Ph)₂GLY]NiBr₂

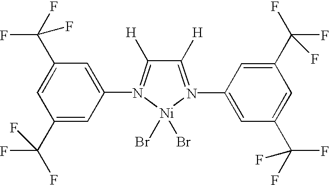

0.2 g [1,2-dimethoxyethane]NiBr₂ and 50 ml dichloromethane are placed together in a 250 ml round-bottomed flask under a N₂ atmosphere and agitated well. 0.3 g ligand are dissolved in 50 ml dichloromethane and slowly added dropwise at room temperature with stirring. On completion of the addition, the experiment is stirred overnight at room temperature. The solvent is removed by distillation. The remaining product is washed 3 times with 20 to ml diethyl ether on each occasion and dried to constant mass in an oil pump.

Yield: 0.31 g

### Example 4

### Synthesis of [(3,5-(CF₃)₂Ph)₂BUD]NiBr₂

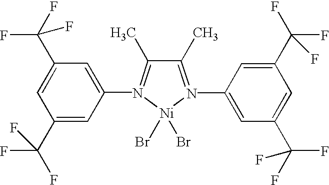

1.0 g [1,2-dimethoxyethane]NiBr₂ and 50 ml dichloromethane are placed together in a 250 ml round-bottomed flask under a N₂ atmosphere and agitated well. 1.6 g ligand are dissolved in 50 ml dichloromethane and slowly added dropwise at room temperature with stirring. On completion of the addition, the experiment is stirred overnight at room temperature. The solvent is removed by distillation. The remaining product is washed 3 times with 20 to 30 ml diethyl ether on each occasion and dried to constant mass in an oil pump.

Yield: 1.97 g

### Example 5-7 Comparative Examples

### Synthesis of [(2-tBuPh)₂BUD]NiBr₂

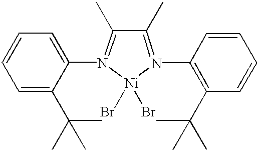

[(2-tBuPh)₂BUD]NiBr₂ was synthesized as directed in the literature (WO 96/23010 example 25 and 185).

### Synthesis of [(2-tBuPh)₂AND]NiBr₂

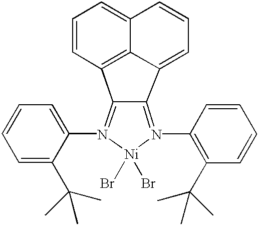

[(2-tBuPh)₂AND]NiBr₂ was synthesized as directed in the literature (WO 96/23010 example 26 and 186).

### Synthesis of [(2,6Me₂Ph)₂BUD]NiBr₂

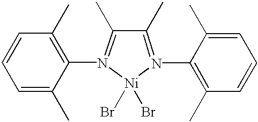

[(2,6Me₂Ph)₂BUD]NiBr₂ was synthesized as directed in the literature (M. Svoboda and H. tom Dieck; J. Organomet. Chem. 191 (1980), 321-328).

### Example 8

### Polymerization of Ethene

380 ml toluene and 2.60 ml of a 10% methyl aluminoxane solution (Witco) are placed at room temperature in a clean reactor rinsed with N₂ and the heating circuit is opened. On reaching polymerization temperature ethene is compressed to 3.4 bar and the solution saturated with ethene. The catalyst solution is then added through a pressure burette and the pressure burette is rinsed with 20 ml toluene. After a polymerization time of 120 min the experiment is cooled and transferred to a 2 l beaker prepared with 500 ml ethanol. 10 ml of an 8% hydrochloric acid are added to the batch, it is stirred for a further 15 min, shaken out twice with 200 ml water and washed and the phases are then separated. The organic phase is evaporated to low volume in a rotary evaporator. The residue is dried in a vacuum drying oven at 60° C./200 mbar.

For the high-temperature gel permeation chromatography, the samples were each dissolved in ortho-dichlorobenzene at 140° C. and measured with a high-temperature GPC unit (Waters 150C) on a combination of 4 20 μm styrene divinyl benzene linear columns (L=300 mm, d=8 mm). Ionol was used as an internal standard for flow correction. A differential refractometer was used to detect the polymer concentration in the eluate. The chromatograms were evaluated quantitatively on the basis of the universal calibration theory using the Mark-Houwink parameters for polyethylene at 140° C. in o-dichlorobenzene.

The viscometry was performed at 140° C. in o-dichlorobenzene with ionol as stabilizer. The samples were measured in a semi-automatic Ubbelohde capillary viscometer in three different concentrations. Mη was calculated from [η] using the Mark-Houwink parameters for polyethene.

TABLE 1
Results of the polymerization of ethene at 30° C., 3.4 bar ethene in toluene.

| | | | | | | | | CH/ |
|---|---|---|---|---|---|---|---|---|
| | Yield | Tg | Tm | M_{w} | Mₙ | M_{w}/ | | 1000 |
| Catalyst | [g] | [° C.] | [° C.] | [g/mol] | [g/mol] | Mₙ | Mη | C |
| [(3,5-(CF₃)₂Ph)₂GLY]NiBr₂ | 5.0 | −30 | 81 | 842000 | 349000 | 2.3 | 599000 | 52 |
| [(3,5-(CF₃)₂Ph)₂BUD]NiBr₂ | 4.0 | −31 | 81 | 678000 | 301000 | 2.4 | 482000 | 49 |
| [(2-tBuPh)₂AND]NiBr₂ | 2.5 | | 115 | | | | 331000 | |
| [(2-tBuPh)₂BUD]NiBr₂ | 0.6 | −29 | 48 | | | | 456000 | |
| [(2,6-Me₂Ph)₂BUD]NiBr₂ | 13.8 | | 111 | | | | 203000 | |

The polymerization results set out in Table 1 show that the novel catalysts, which are not based on o-substituted structures, have a high activity for the polymerization of olefins. The polymers obtained have a high molecular weight.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A diimine transition metal compound comprising aryl groups with one or more electron-attracting substituents.

2. The compound according to claim 1 having the general formula (I) 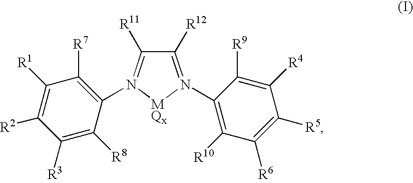
wherein
M is manganese, iron, ruthenium, cobalt, rhodium, nickel, palladium or copper,
Q is a mono-anionic or non-anionic ligand,
R¹, R², R³, R⁴, R⁵, R⁶ are mutually independently selected from the group consisting of electron-attracting substituent, hydrogen, optionally substituted C₁-C₁₀ alkyl groups, optionally substituted C₆-C₁₄ aryl radicals and wherein one or more of R¹ to R⁶ can optionally be parts of a ring system, wherein at least one of these groups is an electron-attracting substituent,
R⁷, R⁸, R⁹, R¹⁰ are mutually independently selected from the group consisting of hydrogen, halogen, C₁-C₁₀ alkyl, C₆-C₁₄ aryl, wherein at least two of the groups are hydrogen or halogen,
R¹¹ and R¹² are mutually independently selected from the group consisting of hydrogen, halogen, substituted C₁-C₁₀ alkyl group, substituted C₆-C₁₄ aryl radical and wherein one or more of R¹¹ to R¹² can optionally be part of a ring system or are bonded by atoms to the imine carbons,
x represents a whole number in the range from 1 to 3.

3. A compound according to claim 2, wherein
M represents Ni or Pd,
Q represents chloride, bromide or methyl,
R¹, R³, R⁴, R⁶ mutually independently represent halogen or perhaloalkyl,
R² and R⁵ represent hydrogen, alkyl or aryl,
R⁷, R⁸, R⁹, R¹⁰ represent hydrogen,
R¹¹, R¹² represent hydrogen, alkyl or rings, and
x is 2 or 3.

4. A compound according to claim 1, wherein one or more compounds selected from the group consisting of halogen, halogenated alkyl groups, nitro, cyano, carbonyl and carboxyl groups are used as electron-attracting group(s).

5. A composition comprising one or more diimine transition metal compounds having aryl groups with one or more electron-attracting substituents and at least one metal complex cation-forming compound, and optionally an alkylating agent.

6. The composition according to claim 5, wherein the diimine transition metal compound comprises aryl groups with one or more electron-attracting substituents and wherein the metal complex cation-forming compound is a cyclic aluminoxane compound and/or coordination complex compound selected from the group consisting of strong, neutral Lewis acids, ionic compounds with Lewis acid cations or Brønsted acid cations and non-coordinating anions.

7. A catalyst comprising one or more diimine transition metal compounds having aryl groups with one or more electron-attracting substituents and at least one metal complex cation-forming compound, and optionally an alkylating agent.

8. The catalyst according to claim 7, wherein the diimine transition metal compound comprises aryl groups with one or more electron-attracting substituents and wherein the metal complex cation-forming compound is a cyclic aluminoxane compound and/or coordination complex compound selected from the group consisting of strong, neutral Lewis acids, ionic compounds with Lewis acid cations or Brønsted acid cations and non-coordinating anions.

9. A catalyst for the polymerization of olefins comprising diimine transition metal compound comprising aryl groups with one or more electron-attracting substituents.

10. A catalyst for the polymerization of olefins comprising one or more diimine transition metal compounds having aryl groups with one or more electron-attracting substituents and at least one metal complex cation-forming compound, and optionally an alkylating agent.

11. The catalyst according to claim 10, wherein the diimine transition metal compound comprises aryl groups with one or more electron-attracting substituents and wherein the metal complex cation-forming compound is a cyclic aluminoxane compound and/or coordination complex compound selected from the group consisting of strong, neutral Lewis acids, ionic compounds with Lewis acid cations or Brønsted acid cations and non-coordinating anions.

12. A process for the homopolymerization or copolymerization of olefins, comprising the step of polymerizing the olefin in the presence of a diimine transition metal compound comprising aryl groups with one or more electron-attracting substituents.

13. A process for the homopolymerization or copolymerization of olefins, comprising the step of polymerizing the olefin in the presence of composition comprising one or more diimine transition metal compounds having aryl groups with one or more electron-attracting substituents and at least one metal complex cation-forming compound, and optionally an alkylating agent.
